(19) United States
(12) Patent Application Publication
(10) Pub. No.: US 2026/0096546 A1
(43) Pub. Date: Apr. 9, 2026

(54) METHOD OF IMPROVING A FISHING LURE

(71) Applicant: John Small, Irmo, SC (US)

(72) Inventor: John Small, Irmo, SC (US)

(21) Appl. No.: 19/028,549

(22) Filed: Jan. 17, 2025

Related U.S. Application Data
(60) Provisional application No. 63/702,833, filed on Oct. 3, 2024.

(51) Int. Cl. A01K 85/00

(52) U.S. Cl. CPC A01K 85/1897; A01K 85/01; A01K 85/12; A01K 85/16; A01K 85/18; B22F 2998/10

(57) ABSTRACT

A method of improving a fishing lure by taking an existing fishing lure and adding a powdered metal such as lead or tungsten to the soft material during the re-production phase to add weight, wherein the amount of added weight enables the resulting improved fishing lure to sink to different depths at a faster sinking rate. The subject disclosure contemplates first-time production of fishing lures with added powdered weight as well as re-production, wherein a pre-existing lure of substantially only soft material is melted down, powdered weight is added to the more viscous, melted soft material, which is then allowed to reconstitute through cooling, thereby resulting in a heavier version of the pre-existing lure.

### CROSS REFERENCE TO RELATED APPLICATION

This application claims the benefit of priority of U.S. provisional application number 63/702,833, filed Oct. 3, 2024, the contents of which are herein incorporated by reference.

### BACKGROUND OF THE SUBJECT DISCLOSURE

The present invention relates to fishing lures and, more particularly, to a method of improving a fishing lure by taking an existing fishing lure manufacturing process and adding a powdered metal such as lead or tungsten to the product during the production phase to add a desired weight, wherein the amount of additional weight enables the resulting improved fishing lure to sink to a preferred depths at a faster speed and so that the improved fish lure ‘swims’more naturally through the water, thereby obviating the need for a sinker.

Fishing as a sport is enjoyed around the world. From fresh water to salt water, a wide variety of fish species exist. Anglers employ a variety of equipment and tackle depending upon the water being fished, the time of day, the species of fish sought, personal choice, and many other factors. A fishing lure, sometimes referred to as an artificial lure, is frequently a part of such equipment and tackle.

Fishing lures are typically designed with the goal of replicating or mimicking the movement and appearance of a food source for the type of fish being sought. For example, such a lure may take on the shape of a minnow, tadpole, frog, mouse, insect, salamander, another fish, or such other food sources. The anglers'hope is that by having a lure closely resembling or acting like a source of food, fish will be enticed into biting the lure and thereby be hooked.

Many fishing lures are made molded of flexible, translucent, soft plasticized, polymeric and/or rubber material into an integral unit in the form of a baitfish. The softness of a fishing lure refers to its flexibility and texture. The subject matter is aimed at not changing the softness of the lure, while adding additional weight that results in a deeper ‘diving’ lure that still or more replicate or mimics the movement and behavior of the baitfish it represents, since ‘harder’ baits usually have better inherently action to them.

A disadvantage of current fishing lures is that they sink at an artificial or unnatural rate. This unnatural rate is a lost opportunity because by failing to mimic the rate of movement of the type of edible sea food it is designed to look like, the sinking fishing lure does not entice the desired fish. And since fish are very transient as they swim around underwater, this lost opportunity may never return.

As there can be seen, there is a need for a method of improving a fishing lure by taking an existing fishing lure-many of which are made from silicone, rubber or various plasticized materials-and adding a powdered metal, such as lead or tungsten, to the plasticized materials during the production (or re-production) phase to add weight, wherein the amount of weight enables the resulting improved fishing lure to sink to different depths and/or at a faster sinking rate.

### SUMMARY OF THE SUBJECT DISCLOSURE

In one aspect of the subject disclosure, a method of improving an existing fishing lure by infusing a powdered metal into the existing fishing lure in a substantial uniform manner during a re-production process.

In another aspect of the subject disclosure, the method of improving an existing fishing lure by infusing a powdered metal into the existing fishing lure in a substantial uniform manner during a re-production process further includes wherein the pre-existing fishing lure comprises a soft material, wherein the soft material wherein the soft material is selected from the group consisting of silicone, rubber, plasticized material, and a combination thereof, wherein the reproduction process includes melting the soft material prior to infusing the powdered metal, wherein the powdered metal is selected from the group consisting of tungsten, lead, steel, and a combination thereof, wherein the re-production process comprising melting the soft material and then mixing the powdered weight therein, and wherein the powdered metal comprises a powdered weight, wherein the soft material comprises a melted weight, and wherein a ratio of powdered weight to melted weight ranges between 8 to 1 and 1 to 8.

These and other features, aspects and advantages of the present subject disclosure will become better understood with reference to the following drawings, description and claims.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

As used herein, directional terms such as upper, lower, upward, downwardly, top, left, right and the like are used in relation to the illustrative embodiments as they are depicted in the figures, such that the upward direction (or upper) being toward the top of the corresponding figures and the downward direction being toward the bottom of the corresponding figures.

A general overview of the various features of the invention will be provided, with a detailed description following. Broadly, an embodiment of the subject disclosure provides a method of improving a fishing lure by taking an existing fishing lure and adding a powdered metal such as lead or tungsten to the soft material during the re-production phase to add weight, wherein the amount of weight enables the resulting improved fishing lure to sink to different depths at a faster sinking rate. The subject disclosure contemplates first-time production of fishing lures with added powdered weight as well as re-production, wherein a pre-existing lure of substantially only soft material is melted down, powdered weight is added to the more viscous, melted soft material, which is then allowed to reconstitute through cooling, thereby resulting in a heavier version of the pre-existing lure. In the fishing industry, a “soft” material for a lure is a moldable, movable product, such as rubber, silicone and various plasticized materials that can be easily deformed, while a “hard” lure is composed of solid segment elements that resist deformation. The term ‘soft’ may be deemed to fall below 50 on a durometer shore A hardness scale, while the term ‘hard’ is above 50 on the durometer shore A hardness scale.

These improved weighted fishing lures allow them to sink to different depths at a faster rate, and the manufacturer can add different amounts of powered metals to the plasticized, polymer, and/or rubber material in a liquid state, thereby selectively enabling faster sinking ratio.

The desired sinking rate results from, or is a function of, the range of the weight ratio (e.g., oz. to oz.) of the liquid state (LS) to the powdered weight (PW), and to some degree the different types of LS and PWs, resulting in different combinations of LS/PW to produce different weight ratios and thus sinking ratios. In an experiment run by the inventor, using a pre-existing soft lure weighing approximately a half an ounce, the sink rate was increased four times by adding one-eighth of an ounce of PW, thereby eliminating the need for a sinker and resulting in an improved lure that ‘swam’ through the water in a way that more accurately mimicked the movement of a food source for a desired fish. It is understood that the desired sink rate depends on the fish being caught, the food source being mimicked, whether reeling will be involved in catching the fish, etc.

In one specific embodiment, a powdered weight (PW) is added during the (re-)manufacturing process to a liquid state (LS) of a silicone-based fishing lure for the purpose of adding weight to make it sink faster or swim at different depths, and so to remove the need to add sinkers or weights to the fishing lure to do the same thing. The PW will have to be added while the lure is still in liquid state before molding. The ratio of material can vary from approximately ⅛ oz. of PW to approximately 1 oz. of LS and can be as high as approximately 1 oz. of PW to approximately ⅛ oz. LS. The PW can comprise several types of powdered metals such as tungsten, lead, steel, and other metal types. The LS can comprise of different materials such as soft plastic, silicone, rubber, and other flexible materials. The resulting improved fishing lure has the PW embedded, implanted, infused throughout its body, in a substantially uniform manner.

As tested, a four-inch minnow with approximately ½ oz. of powdered tungsten added will swim at a depth of two to three feet, while the same size minnow made with the same material excluding the tungsten will only swim at surface level at the same speed.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A method of improving an existing fishing lure by infusing a powdered metal into the existing fishing lure in a substantial uniform manner during a re-production process.

2. The method of claim 1, wherein the pre-existing fishing lure comprises a soft material, wherein the soft material wherein the soft material is selected from the group consisting of silicone, rubber, plasticized material, and a combination thereof.

3. The method of claim 2, wherein the reproduction process includes melting the soft material prior to infusing the powdered metal.

4. The method of claim 3, wherein the powdered metal is selected from the group consisting of tungsten, lead, steel, and a combination thereof.

5. The method of claim 4, wherein the re-production process comprising melting the soft material and then mixing the powdered weight therein.

6. The method of claim 5, wherein the powdered metal comprises a powdered weight, wherein the soft material comprises a melted weight, and wherein a ratio of powdered weight to melted weight ranges between 8 to 1 and 1 to 8.
